(19) United States
(12) Patent Application Publication
(10) Pub. No.: US 2002/0035631 A1
(43) Pub. Date: Mar. 21, 2002

(54) Method and system for establishing communication link between host computer provided with multiple communication tools and communication network

(76) Inventors: Kevin Chung, Junghe City (TW); Su-Fang Chu, Banchiau City (TW); Chia-Fang Tsai, Taipei (TW)

Correspondence Address: Eric Bleich, Trademark and Patent Counselors of America, P.C., 915 Broadway, 19th Floor, New York, NY, 10010-7108, US

(21) Appl. No.: 09/767,056

(22) Filed: Jan. 22, 2001

(30) Foreign Application Priority Data
Sep. 21, 2000 (TW) 89119522

(51) Int. Cl. G06F 15/16; G06F 15/173

(52) U.S. Cl. 709/227; 709/239; 709/250

(57) ABSTRACT

A method and system for establishing a communication link between a host computer provided with multiple communication tools and a communication network is characterized in that the at least two communication tools are provided with the host computer and the default communication tool (which is a built-in LAN device) thereof is designated as the communication tool to establish a communication link between the host computer and a corresponding remote server (LAN server) which can provide a network access to the communication network. The LAN server will be polled by a network diagnostic apparatus such as a ping utility to determine whether the LAN server is accessible. If the LAN server is accessible, a communication link can be established between the host computer which serves as a client and the communication network over the link of the client and the LAN server. If the LAN server is inaccessible, another communication tool will be designated as the communication tool to establish communication link between the host computer which serves as a client and the communication network.

### FIELD OF THE INVENTION

The present invention is relative to a method and system for establishing communication link between a host computer provided with multiple communication tools and a communication network.

### BACKGROUND OF THE INVENTION

Currently, the target for rapid information distribution has been attained by the popularization of the Internet service accommodation. By using a personal computer together with a communication tool such as a modem (modulator-demodulator), people can share information with other people and acquire necessary stuffs from Internet. The network technology, however, is continuously advancing concomitant with the mushroom growth of the Internet activities. Thus far, the most common approach for establishing communication link with Internet is through a modem. The host computer at the client side can utilize a modem to establish a communication link with the Internet by first connecting to a remote telephone server that is capable of providing network accesses to the Internet, and then the host computer can connect with the Internet over the telephone line through the remote telephone server.

Nonetheless, the data transmission speed over the telephone line is limited up to 56000 bps (bits per second). In order to improve the communication quality and broaden the communication bandwidth, various communication tools that can achieve wide-bandwidth communication link are gradually developed, for example, cable modem, ISDN (integrated service digital network) modem, ADSL (asymmetric digital subscriber line) modem, and satellite communication plants. The data transmission speed over such wide-bandwidth communication tools has exceeded 56000 bps, and the communication quality is better than that over a modem.

Therefore, people now have numerous selections for the communication tools, and a variety of communication tools may be provided with the host computer. When one intends to establish a communication link between the host computer and the Internet, mostly a single communication tool will be designated and a corresponding server will be polled to determine whether it is accessible to establish a communication link with the Internet. If the server is not accessible, another communication tool will then be designated and the corresponding server will be polled, and a communication link between the host computer and the communication network will be established based on this communication tool.

The applicant is therefore tried to develop a method and system for establishing communication link between a host computer provided with multiple communication tools and a communication network, in which the switching process for the communication link procedure can be carried out in an automatic and simplified way.

### SUMMARY OF THE INVENTION

An object of the present invention is to provide a method for establishing a communication link between a host computer and a communication network, in which multiple communication tools are provided with the host computer.

Another object of the present invention is to develop a system in a host computer for establishing a communication link between the host computer and a computer network.

To this end, a method for establishing a communication link between a host computer and a communication network, wherein the host computer is provided with at least two communication tools, is provided and includes the steps of: (a) initializing network connection parameters of the host computer and sending out a network connection request to a first communication tool, (b) polling a server which is capable of providing a network access to the communication network over the first communication tool by means of a network diagnostic apparatus to determine whether the server is accessible over the first communication tool, (c) establishing a communication link between the first communication tool and the server which is capable of providing a network access to the communication network over the first communication tool if the server which is capable of providing a network access to the communication network over the first communication tool is determined to be accessible over the first communication tool, and (d) establishing a communication link between a second communication tool and a server which is capable of providing a network access to the communication network over the second communication tool if the server which is capable of providing a network access to the communication network over a first communication tool is determined to be inaccessible over the first communication tool.

Preferably, the first communication tool is built in the host computer, for example, a local area network (LAN) device or a modem (modulator-demodulator) device. On the other hand, the first communication tool or the second communication tool respectively can be an externally connected communication tool, for example, a modem (modulator-demodulator) device, a cable modem, an integrated service digital network (ISDN) modem, an asymmetric digital subscriber line (ADSL) modem, or a satellite communication plant. In addition, the network diagnostic apparatus includes a ping utility.

Another aspect of the present invention includes a system in a host computer for establishing a communication link between the host computer and a communication network, and the system includes at least two communication tools, each of which is operable in response to a network connection request to establish a communication link with a server which is capable of providing a network access to the communication network over the communication tool, and a microprocessor for initialing network connection parameters of the host computer and sending a network connection request to a first communication tool to establish a communication link between the host computer and the communication network over the first communication tool, and resending a network connection request to a second communication tool to establish a communication link between the host computer and the communication network over the second communication tool if a server which is capable of providing a network access to the communication network over the first communication tool is determined to be inaccessible.

The aforementioned system further includes an I/O control device for controlling a data flow among the microprocessor and the communication tools, and a network diagnostic apparatus for polling the server to determine whether the server is accessible over the communication tool.

Normally, the network diagnostic apparatus includes a ping utility, and the first communication tool is built in the host computer, for example, a local area network (LAN) device or a modem (modulator-demodulator) device.

Alternatively, the first communication tool or the second communication tool respectively can be an externally connected communication tool, for example, a modem (modulator-demodulator) device, a cable modem, an integrated service digital network (ISDN) modem, an asymmetric digital subscriber line (ADSL) modem, or a satellite communication plant.

Now the foregoing and other features and advantages of the present invention will be more clearly understood through the following descriptions with reference to the accompanying drawings, in which:

### BRIEF DESCRIPTION OF THE DRAWINGS

FIG. 1(a) is a block diagram schematically showing an exemplary system for establishing a communication link between a host computer provided with multiple communication tools and a communication network according to the present invention; and

FIG. 2(a) to FIG. 2(c) are flow charts illustrating the method for establishing a communication link between a host computer and a communication network, in which multiple communication tools are provided with the host computer.

### DETAILED DESCRIPTION OF THE PREFERRED EMBODIMENT

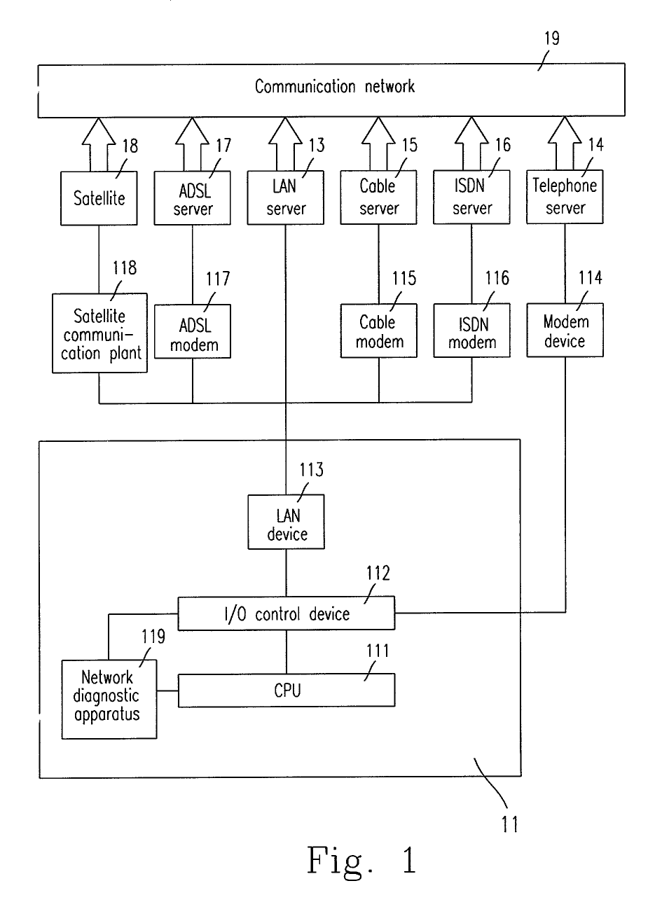

Referring now to FIG. 1, an exemplary example of the system provided for establish a communication link between the host computer and the communication network according to the present invention is illustrated. The host computer 11 includes at least a central processing unit (CPU) 111 and an I/O control device 112. A variety of communication tools are provided with the system of the present invention for the purpose of establishing a communication link between the host computer 11 and the communication network 19. The communication tool can be, but not limited to, a built-in local area network (LAN) device 113, a modem device 114 which can be either built-in or externally connected, a cable modem 115, an ISDN (integrated service digital network) modem 116, an ADSL (asymmetric digital subscriber line) modem 117, and satellite communication plants 118.

As a result, there exists a variety of selections for achieving the communication link between the host computer 11 and the communication network 19. As long as the host computer 11 can access the corresponding remote server which is capable of providing a network access to the communication network 19 with one of the aforesaid communication tools provided with the host computer over adequate communication cables, the communication link can be established between the host computer 11 which serves as a client and a communication network 19 through the remote server which serves as a network access provider. The I/O control device 112 of the host computer 11 functions as a data flow controller to control the data flow among the CPU 111 and the communication tools.

The default communication tool according to a preferred embodiment of the present invention is designated with a local area network (LAN) device 113. The corresponding server which can provide a network access to the communication network 19 over the LAN device 113 is a LAN server 13. In an analogous manner, the corresponding server which can provide a network access to the communication network 19 over the modem device 114 is a telephone server 14. The cable modem 115, ISDN modem 116, ADSL modem 117, and satellite communication plants 118 provided with the host computer 11 are connected to the cable server 15, ISDN server 16, ADSL server 17, and satellite 18 through television cable, ISDN cable, ADSL cable, and optical fiber cable respectively, and the communication link can be established between the host computer 11 and the communication network 19 through the link of the client and the remote server.

Further to the present invention, a network diagnostic apparatus 119, for example, a ping utility, is provided with the system and conducted to poll the remote server to determine whether the remote server is accessible. The ping utility which selects low-priority network protocol known as ICMP protocol to diagnose the communication status between the client and server allows a host computer connected to the communication network to determine whether a remote server is accessible. The host computer which serves as a client sends out an ICMP request to poll the remote server, and if the IP software installed on the destination machine (remote server) receives the ICMP request and issues an echo reply immediately, the remote server will be determined to be accessible. If the remote server is polled and found to be accessible, then a communication link between the client and the remote server which serves a network access provider is established.

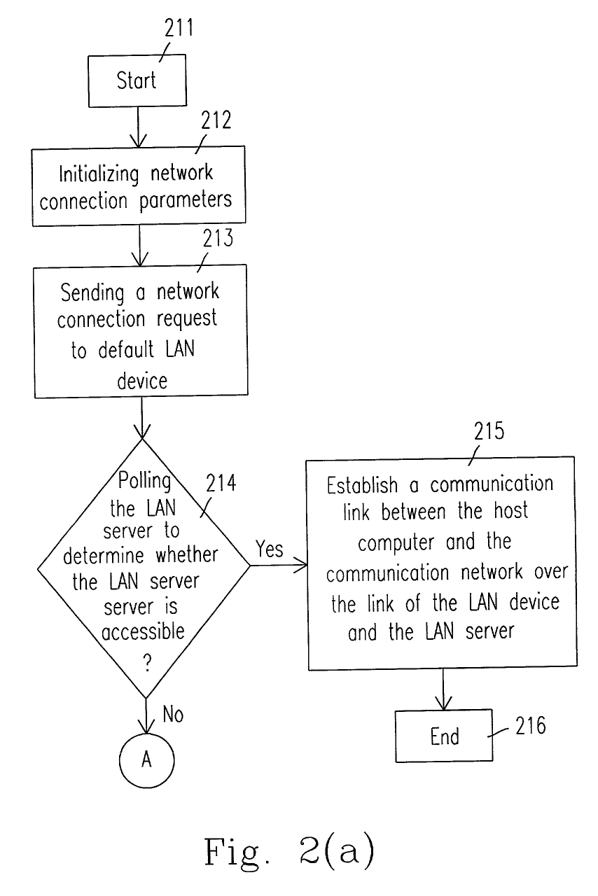

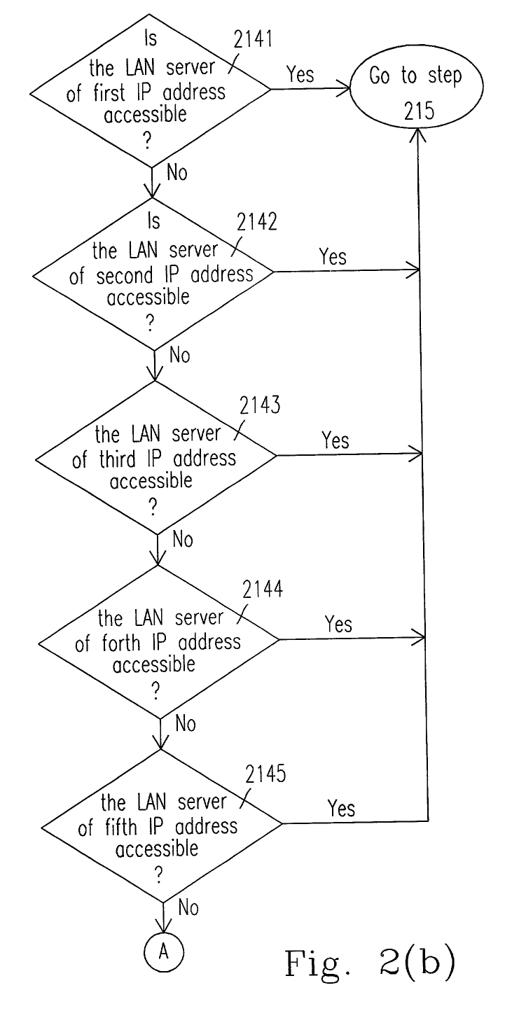

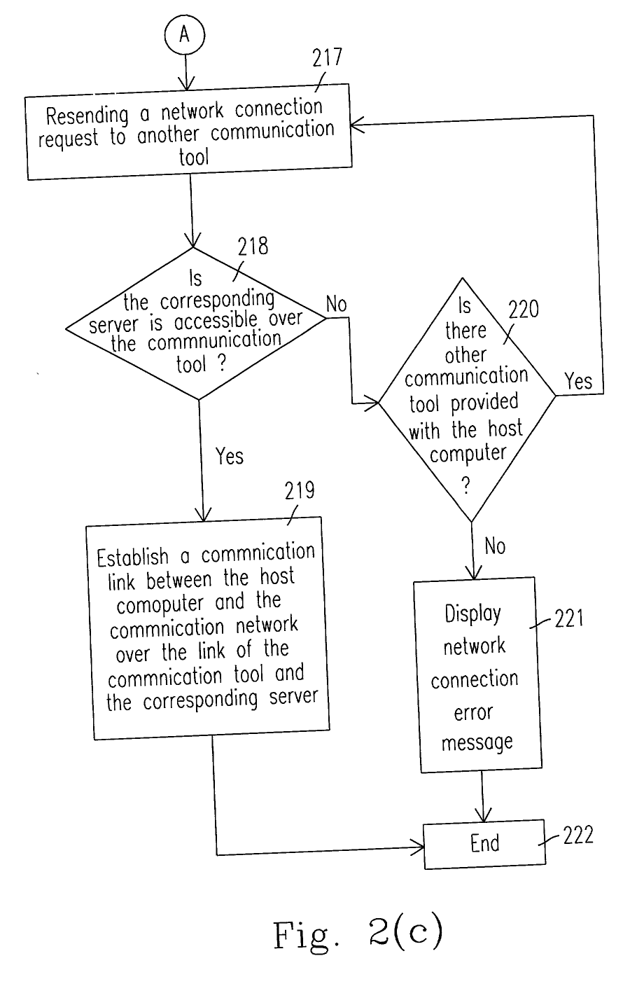

The method for establishing a communication link between a host computer provided with multiple communication tools and a computer network can be best understood from the following step-by-step description accompanied with the flow charts of FIG. 2(a) through FIG. 2(c). The method for establishing a communication link between a host computer provided with multiple communication tools according to the present invention starts at step 211. When a network application program such as video conference application program, world wide web (WWW) browser, is started, the central processing unit of the host computer will initialize the network connection parameters of the host computer (step 212) and sending out a network connection request to the default communication tool provided With the host computer (which is designated as a LAN device in the preferred embodiment) at step 213. The LAN device will attempt to make a communication link with the LAN server. In the mean time, a network diagnostic apparatus, for example, a ping utility, will be activated to poll the remote LAN server to determine whether the remote LAN server is accessible (determinant 214). If the remote LAN server is accessible, at step 215 a communication link between the host computer and the communication network will be established over the link of the LAN device and the LAN server. Then, one can start to download data from the communication network to the host computer and upload data from the host computer to the communication network over the LAN cable.

The determinant 214 in FIG. 2(a) can be further decomposed into a plurality of sub-determinants, as shown in FIG. 2(b). In FIG. 2(b), at the determinant of polling the remote LAN server, five different machines each of which has a different Internet protocol (IP) address at the LAN server side are set to be polled in the preferred embodiment. The Internet protocol address (IP address) indicates the address of each machine on the Internet. The five machines at the LAN server side are sequentially polled to determine whether they are accessible at sub-determinants 2141 to 2145. If the five machines at the LAN server side are determined inaccessible, then another communication tool will be designated as the communication tool to establish communication link between the host computer and the communication network.

Turning to FIG. 2(c), If the default LAN server is determined to be inaccessible, another communication tool provided with the host computer is active to establish a communication link between the host computer and the communication network by resending a network connection request to another communication tool (step 217). Thereafter, an attempt will be made to establish a communication link between the corresponding network access provider (remote sever) and the host computer at the client side by polling the remote server to determine whether the remote server is accessible (determinant 218). If the remote server is accessible, then a communication link will be established between the host computer and the communication network over the link of the communication tool and the remote server (step 219). If the remote server is inaccessible, the CPU of the host computer will detect if there are other communication tools provided with the host computer at the determinant 220. If yes, another communication tool will designated to establish communication link between the host computer and the communication network, and thus the process for establishing communication link between the host computer and the communication network goes back to step 217. If no, at step 221 a network connection error message will be displayed on the screen of the host computer, and the network communication process will be terminated.

In summary, the system and method according to the present invention utilizes a default communication tool to establish communication link between the host computer and the communication link, and can automatically switch to another communication tool to establish communication link between the host computer and the communication network if the remote server which can provide a network access to the default communication toll is determined to be inaccessible. Thus, the switching process for the communication link procedure can be carried out automatically, people do not need to be aware which communication tool is accessible to the corresponding server.

Although the present invention has been described and illustrated in detail, it is to be clearly understood that the same is by the way of illustration and example only and is not to be taken by way of limitation, the spirit and scope of the present invention being limited only by the terms of the appended claims.

What we claim is:

1. An method for establishing a communication link between a host computer and a communication network, wherein said host computer is provided with at least two communication tools, said method comprising the steps of:
(a) initializing network connection parameters of said host computer and sending out a network connection request to a first communication tool;
(b) polling a server which is capable of providing a network access to said communication network over said first communication tool by means of a network diagnostic apparatus to determine whether said server is accessible over said first communication tool;
(c) establishing a communication link between said first communication tool and said server which is capable of providing a network access to said communication network over said first communication tool if said server which is capable of providing a network access to said communication network over said first communication tool is determined to be accessible over said first communication tool; and
(d) establishing a communication link between a second communication tool and a server which is capable of providing a network access to said communication network over said second communication tool if said server which is capable of providing a network access to said communication network over a first communication tool is determined to be inaccessible over said first communication tool.

2. The method as set forth in claim 1, wherein said first communication tool is built in said host computer.

3. The method as set forth in claim 2, wherein said first communication tool comprises a local area network (LAN) device.

4. The method as set forth in claim 2, wherein said first communication tool comprises a modem (modulator-demodulator) device.

5. The method as set forth in claim 1, wherein said first communication tool comprises one selected from a group consisting of a modem (modulator-demodulator) device, a cable modem, an integrated service digital network (ISDN) modem, an asymmetric digital subscriber line (ADSL) modem, and a satellite communication plant.

6. The method as set forth in claim 1, wherein said network diagnostic apparatus comprises a ping utility.

7. The method as set forth in claim 1, wherein said second communication tool comprises one selected from a group consisting of a modem (modulator-demodulator) device, a cable modem, an integrated service digital network (ISDN) modem, an asymmetric digital subscriber line (ADSL) modem, and a satellite communication plant.

8. In a host computer, a system for establishing a communication link between a host computer and a communication network, comprising:
at least two communication tools, each of which is operable in response to a network connection request to establish a communication link with a server which is capable of providing a network access to said communication network over said communication tool; and
a microprocessor for initialing network connection parameters of said host computer and sending a network connection request to a first communication tool to establish a communication link between said host computer and said communication network over said first communication tool, and resending a network connection request to a second communication tool to establish a communication link between said host computer and said communication network over said second communication tool if a server which is capable of providing a network access to said communication network over said first communication tool is determined to be inaccessible.

9. The system as set forth in claim 8, further comprising an I/O control device for controlling a data flow among said microprocessor and said communication tools.

10. The system as set forth in claim 8, further comprising a network diagnostic apparatus for polling said server to determine whether said server is accessible over said communication tool.

11. The system as set forth in claim 8, wherein said network diagnostic apparatus comprises a ping utility.

12. The system as set forth in claim 8, wherein said first communication tool is built in said host computer.

13. The system as set forth in claim 12, wherein said first communication tool comprises a local area network (LAN) device.

14. The system as set forth in claim 12, wherein said first communication tool comprises a modem (modulator-demodulator) device.

15. The system as set forth in claim 8, wherein said first communication tool comprises one selected from a group consisting of a modem (modulator-demodulator) device, a cable modem, an integrated service digital network (ISDN) modem, an asymmetric digital subscriber line (ADSL) modem, and a satellite communication plant.

16. The system as set forth in claim 8, wherein said second communication tool comprises one selected from a group consisting of a modem (modulator-demodulator) device, a cable modem, an integrated service digital network (ISDN) modem, an asymmetric digital subscriber line (ADSL) modem, and a satellite communication plant.
